(19) United States
(12) Patent Application Publication
(10) Pub. No.: US 2002/0039138 A1
(43) Pub. Date: Apr. 4, 2002

(54) Method and apparatus for automatically adjusting video panning and zoom rates

(76) Inventors: Steven D. Edelson, Wayland, MA (US); Ralph J. Carballal, Riviera Beach, FL (US)

Correspondence Address: VENABLE, BAETJER, HOWARD AND CIVILETTI, LLP, P.O. BOX 34385, WASHINGTON, DC, 20043-9998, US

(21) Appl. No.: 09/963,498

(22) Filed: Sep. 27, 2001

Related U.S. Application Data
(60) Provisional application No. 60/236,346, filed on Sep. 29, 2000.

(51) Int. Cl. H04N 5/228

(52) U.S. Cl. 348/208

(57) ABSTRACT

In a video processing system a video processor is connected to receive a video from a video motion picture source. The video processor detects when a sequence of frames in a received video represents camera motion such as camera panning rates or camera zooming rates outside of predetermined guidelines. The system corrects for the guidelines being exceeded by retiming the video frames to be within the guidelines and then produces new frames by interpolation at standard video frame rates between the retimed frames.

The benefits of copending provisional application Ser. No. 60/236,346, filed Sep. 29, 2000, entitled Method and Apparatus for Adjusting Video Panning and Zoom Rates, is claimed.

### BACKGROUND OF THE INVENTION

1. Field of the Invention

The present invention relates generally to image correction in videography, and more particularly to correction of improperly timed pans, zooms and rotations in videography.

2. Related Art

When video is shot by professionals, there are certain guidelines as to camera movements which are desirable and those which are not desirable. Parenthetically, we acknowledge that artistic techniques often violate the “rules of thumb”, but here we are interested in the mainstream video photography.

As people started shooting home movies, first with 8 mm film and then with video, there emerged millions of amateur photographers who lacked the training and manual skills of the professional. The result was the all-too-familiar uncomfortably jerky and bouncing video.

With the switch from film to video, the possibility of electronic correction and control has emerged. One problem of an amateur video is the shakiness that results from hand-held cameras. Professionals use tripods and dollies to assure solid camera placement and smooth movement. When professionals move on foot, they use a sophisticated camera stabilizing system, for example, Steadicam® of Tiffen Company.

Amateurs do not have the benefit of these professional tools and usually shoot unassisted while standing and walking. The resulting video is jumpy and jerky. To help the situation, some newer video cameras have an electronic “steady” system that detects high-frequency camera movement and electronically re-centers the image so to remove these high-frequency, small movements by the amateur camera operator.

There are also techniques in the art that can examine an electronic video file after it has been shot and identify the camera motion from images within the file. With this information, the techniques then retroactively move the video images within the frame borders to correct for the shakiness of the camera operator. This is a retroactive version of the camera stabilization systems. These can be quite effective at removing high-frequency small-scale movements by the operator.

The emphasis on high-frequency movements in the above description has been intentional to differentiate shakiness from another common defect in amateur video photography. This defect is the tendency of amateurs to “pan” or “zoom” the camera too quickly. Panning is the act of sweeping the camera horizontally across the scene (also vertically to look up at tall buildings, mountains, etc.). Zooming is the act of increasing or decreasing the magnification of the lens to bring the subject matter closer or to appear to move back to take in a wider range of the scene. A second, less objectionable variant is to pan or zoom in an unsteady sweep or velocity pattern.

The image movement in both a fast-pan and an “irregular speed” pan has a much lower frequency than the shakiness that is cured by the camera steady-circuits and the software retroactive steady-cam. These pan errors span many frames, as many as one hundred. Where the retro-active steady-cam works to reposition the image within a frame, curing the pan speeds involves correction, re-timing and regeneration of long sequences of frames. As such, the pan errors cannot be addressed by these electronic camera stabilizers or by software retro-steady-cam techniques.

Motion errors can also be present in camera rotation, where the camera itself is rotated about the axis of the camera lens.

### SUMMARY OF THE INVENTION

It is a goal of this invention to use the camera motion information within a video file to evaluate whether the camera operator has followed specified guidelines of panning, zooming and/or rotation and further, to correct video sequences where such guidelines have been exceeded.

The guidelines can include speed, acceleration or any other desired function. The units of the measurement are relevant to the visual effect being evaluated. In panning, for example, the measure could be the speed of the movement across the frame in frame units.

Once a guideline is detected as having been exceeded, the invention re-times the frames to bring the parameters within the guidelines or at least to mitigate the effect of the guideline being exceeded. If multiple guidelines are exceeded, then the frames are re-timed to correct the worst-case parameter. If the guidelines are opposed so that fixing one will do damage to another, then a priority scheme can be implemented to give priority to correcting some of the parameters over other parameters.

In accordance with the method of the invention, video with an undesirable camera motion rate is corrected by detecting the existence of the undesirable camera motion rate represented in a sequence of video frames comprising the motion picture. The frames of the sequence of video frames are retimed in accordance with a desirable camera motion rate. New frames may be generated at predetermined frame times by interpolating between the retimed frames to produce a video representing camera motion at the desirable camera motion rate.

In the system of the invention, for correcting a video for undesirable camera motion rate, a video motion picture source is connected to a video processor. The video processor operates to identify a sequence of frames in a video in which the camera exceeds at least one guideline and retimes the frames in the sequence to mitigate the effect of the guideline being exceeded. The video processor may then generate new frames interpolated between the retimed frames to represent camera motion in which the excessive camera motion is mitigated.

Further features and advantages of the invention, as well as the structure and operation of various embodiments of the invention, are described in detail below with reference to the accompanying drawings.

### BRIEF DESCRIPTIONS OF THE DRAWINGS

The foregoing and other features and advantages of the invention will be apparent from the following, more particular description of a preferred embodiment of the invention, as illustrated in the accompanying drawings wherein like reference numbers generally indicate identical, functionally similar, and/or structurally similar elements. The left most digits in the corresponding reference number indicate the drawing in which an element first appears.

FIG. 1 depicts an exemplary embodiment of a video processing system according to the present invention.

FIG. 2 is a flowchart illustrating the method of the present invention.

FIG. 3 is a timing diagram depicting an exemplary correction of a too-slow pan according to the present invention.

FIG. 4 is a timing diagram depicting an exemplary correction of a too-fast pan according to the present invention.

### DETAILED DESCRIPTION OF AN EXEMPLARY EMBODIMENT OF THE PRESENT INVENTION

Although the following description is centered primarily on correcting panning motion, the techniques and concepts described below apply equally to zoom and rotation correction according to the present invention.

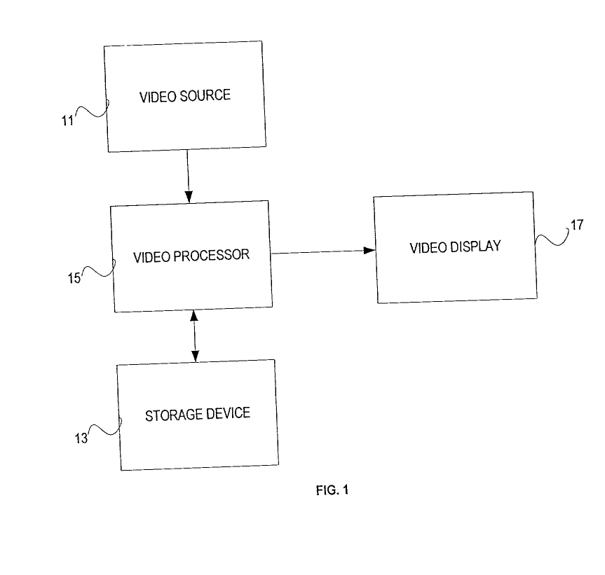

FIG. 1 depicts an exemplary embodiment of a video processing system according to the present invention. The processing begins with a video source 11. The video source 11 can be, for example, a camera, an input feed from a broadcast or the Internet, or a computer storage device such as a disk drive or CD.

The video processor 15 examines and changes the video. The changed video can then be stored for later use on a computer storage device 13 or output directly for display on the video display 17. The video device 17 can be directly connected to the video processor 15 or may be remotely connected via broadcast, Internet, satellite, or some other method.

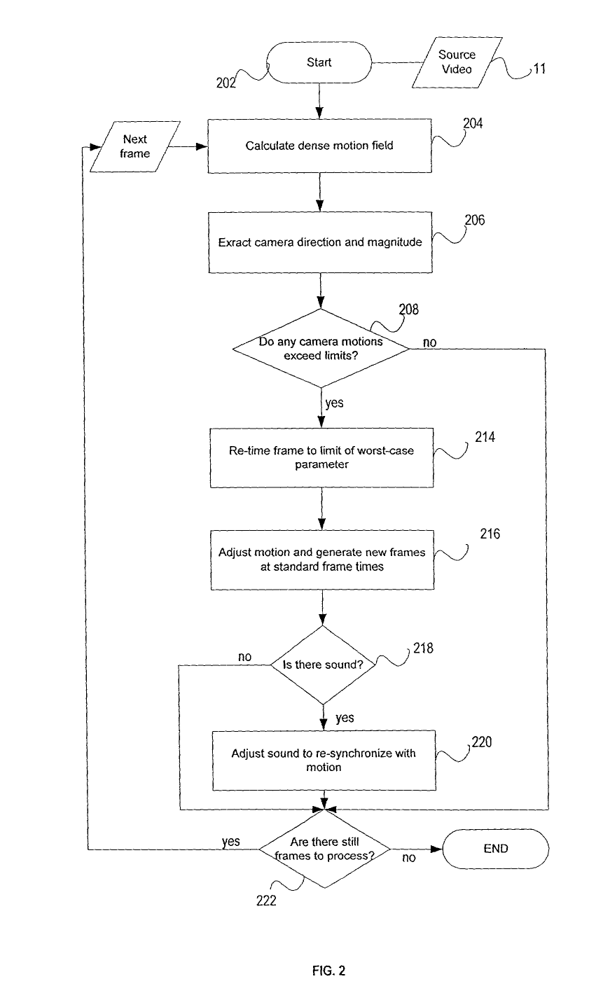

FIG. 2 is a flowchart illustrating the single-pass method of the present invention as performed by the video processor 15. The source video 11 enters the processor in step 202. The source video 11 may be stored for processing as a whole, which enables multi-pass processing, or it may be processed in one pass. The single pass outputs each successive corrected frame in a pipe-line function, which enables in-line correction for broadcast.

In step 204, each input frame is evaluated for motion and, in the preferred embodiment, a dense motion field is created representing the motion between the preceding frame and the evaluated frame or between the evaluated frame and the succeeding frame, or the average of both to obtain the dense motion field representing motion at the evaluated frame. The dense motion vector fields represent the movement of image elements from frame to frame, an image element being a pixel-sized component of a depicted object. When an object moves in the sequence of frames, the image elements of the object move with the object. A method and apparatus for generating a dense motion vector field for a motion picture where the motion of pixel sized image elements from frame to frame is detected and represented by vectors is disclosed in a co-pending application entitled, “System for the Estimation of Optical Flow”, Ser. No. 09/593,521, filed Jun. 14, 2000 by Siegfried Wonneberger, Max Griessl, and Markus Wittkop. This co-pending application is hereby incorporated by reference in its entirety.

From this dense motion field, camera motion direction and magnitude are mathematically extracted from the dense motion field in step 206. Techniques for the mathematical extraction of direction and magnitude of camera motion are known in the art. For example, to detect the camera motion from the dense motion vector fields, the predominant motion represented by the vectors is detected. If most of the vectors are parallel and of the same magnitude, this fact will indicate that the camera is being moved in a panning motion in the direction of parallel vectors and the rate of panning of the camera will be represented by the magnitude of the parallel vectors. If the motion vectors extend radially inwardly and are of the same magnitude, then this will mean that the camera is being zoomed out, and the rate of zooming will be determined by the magnitude of the vectors. If the vectors of the dense motion vector field extend radially outward and are of the same magnitude, then this will indicate that the camera is being zoomed in. If the vectors of the dense motion vector field are primarily tangential to the center of the frames, this means that the camera is being rotated about the camera lens axis. Analyzing the dense motion vector fields and determining the predominant characteristic of the vectors determines the type of camera motion occurring and the magnitude of the camera motion.

Instead of using the dense motion vector fields to detect camera motion, other methods, known in the art, may be used.

The extracted camera motions are compared against allowable camera motion limits in comparison step 208. The allowable motion limits might include, for example, camera motion speed, acceleration monotonicity or a filter function, such as, e.g., frequency lowpass or bandpass.

Further, the allowable motion limits can co-depend in the sense that a zoom faster than speed X is not allowable unless the pan is faster than speed Y. The rules can be arbitrarily complex and depend on any aspect of the video. In one example, pans can be allowed to be faster if the scene is brighter. In another example, the allowable motion limits can be tied to the cadence of the background music.

If the allowable motion limits are not exceeded, the process repeats on the next frame at step 204. If the allowable motion limits are exceeded, then processing is continued in step 214.

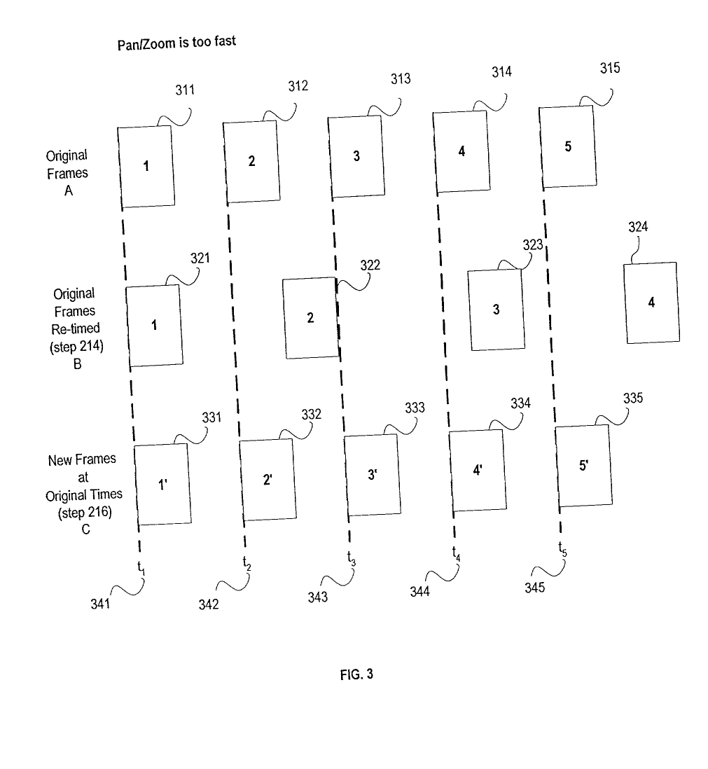

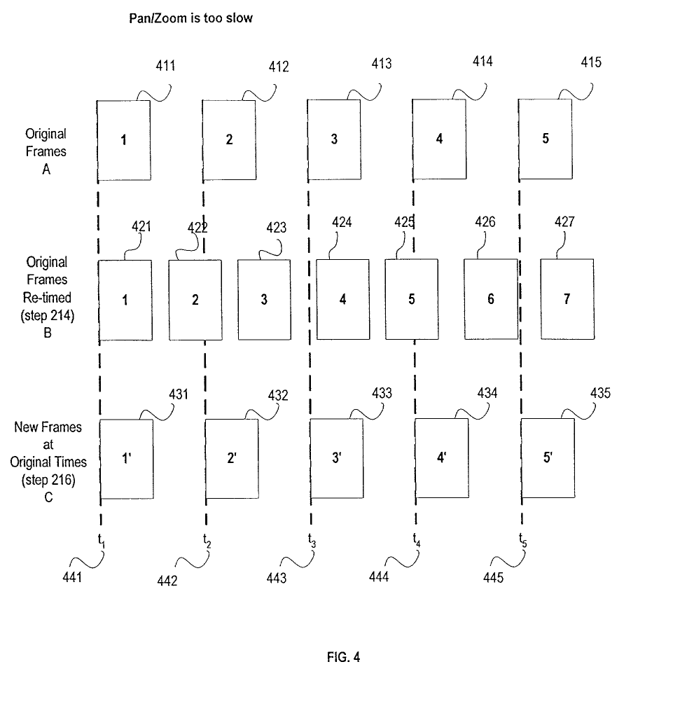

In step 214, the video processor re-times the frame to place it such that the motion or motions fall within the guidelines. Two sample actions of this block 214 are shown in FIGS. 3 and 4 and will be described below.

In the simple case, the frames are placed at times such that the desired motion parameters are not exceeded, but in the preferred embodiment, the placement of these frames would have some lowpass or damped “momentum” to place the frames without disturbing speed steps or oscillations.

Although it is possible to specify arbitrary frame times within the processing block, the typical video system requires frames to be aligned on regular display intervals. For example, if the video is to be displayed at a rate of 25 frames-per-second, then in the typical video system, the display time for all frames within the video must be specified as one of the aligned 40 ms intervals.

In the preferred embodiment, in step 216, the video processor takes in the irregularly timed frames and generates new frames that are aligned to the desired output frame rate times (usually the same as the input frame rate times). In a copending application entitled, “Motion Picture Enhancing System” Ser. No. 09/459,988, filed Dec. 14, 1999 by Steven Edelson and Klaus Diepold, there is disclosed a method and apparatus for generating and inserting new frames at a desired output rate that is different from the input frame rate. In the system disclosed in this application, the new frames are created by interpolation using dense motion vector fields from the existing frames. This co-pending application is hereby incorporated by reference. Other methods of frame interpolation may be used to generate new frames.

Some modern video systems do not require the video frames to be aligned on regular display intervals, in which case the step 216 may be eliminated or used only to optionally add frames as needed such as to eliminate jerky motion, which occurs when the frames are too widely spaced in time.

After the new frame or frames have been generated, there is a test at step 218 to determine if there is a soundtrack in the video. If so, then the timing of the sound samples is adjusted in step 220. The sound adjustment can be a simple re-timing of the sound data, although this would result in a disturbing raising and lowering of the pitch of the sound as the video speeds up and slows down. Alternatively, the technique of “pitch shifting” can be used to compensate the sound pitch in opposition to the speed change so the pitch remains constant through the video changes. Such pitch shifters are well known and commercially available.

The process described in FIG. 2 depicts a one-pass correction without any method shown to back up and re-consider past frames. In another exemplary embodiment, the present invention can allow for multi-pass correction where the entire video can be examined and then corrected in a second pass, starting again at step 202.

Multi-pass correction allows more sophisticated corrections to be performed, including applying corrections to frames before those where the problems occur. For example, in addition to spreading out frames that have too fast a pan, spreading the frames before and after the pan can lessen the apparent change in the video pace.

In another exemplary embodiment, a one-pass system can implement the “spread-out” corrections by keeping a number of frames in a buffer and not releasing them until a suitable number of frames beyond them have been fully examined.

FIG. 3 shows a sample action, in three parts A, B and C, by the frame re-timing step 214 and the new frame generation step 216 of the video processor 15. In this example, the panning is too fast so the video must be slowed down. It is important to note that the example of FIG. 3 can also apply equally to a zoom or a rotation that is too fast. In part A, the original frames 311-315 start on the proper frame times 341-345, respectively.

In part B, when the frame re-timing step 214 is activated as a result of the panning speed being too fast, and thus beyond the allowable guidelines, frame re-timing step 214 corrects the fast motion of the pan by moving the frames farther apart in time, effectively slowing the motion. Assuming that frame 1 at time position 311 stays in its original position on frame time 341, frame 2 at time position 312 is moved to a new position 322. Likewise, frame 3 at time position 313 is moved to position 323 and frame 4 at time position 314 is moved to time position 324. In the example, this movement in time could be approximately a 40% slow-down, i.e. 10 seconds of video becomes 14 seconds of video.

In the retiming as described above, the time of the first frame of the retimed sequence is normally not changed. The times of the other frames will usually, but not necessarily, be changed as required to achieve representation of a desired camera motion.

The moved frames at time positions 322, 323 and 324 are not on proper frame times 341-345 and are thus not easily displayed at their new times in typical video systems. To produce a valid video stream for such video systems, new frames must be generated in step 216 that are on the standard frame times 341 345.

Part C shows the generated frames labeled 1′-5′. The time positions of frames 1′-5′ are numbered 331-335, respectively. These frames are not copies of the original frames, but are generated by interpolation from the originals with image adjustments for the time difference between the new time placement of the original frames at time positions 321-324 and the required time positions of 331-335. The adjustments have to do with the change in position of the contents of the frame due to the pan, zoom or scroll that is being effected, plus any change in position of the contents of the frame due to objects moving (e.g. a person walking).

To properly generate frames 1′-5′ at time positions 331-335, both the above image movements must be interpolated to make sure that every image element is in the proper position for the times 341-345 when the generated frames at time positions 331-335 will be displayed.

Frames 1 and 2 at time positions 311, 312 are separated in time and placed as frames 1 and 2 at time positions 321, 322. These two frames and their camera motion estimates, along with their dense motion field for object motion, are used to create by interpolation the new frame 2′ at time position 332 to be displayed at time 342. Likewise, Frame 2 at time position 322 and Frame 3 at time position 323 are used to create both 3′ at time position 333 at time 343 and frame 4′ at time position 334 at time 344. This process continues through the entire set of re-timed segments.

The result of the example shown in FIG. 3 is that more time is needed to arrive from the image shown in frame 1 to the image shown in frame 5, effectively slowing down the pan.

FIG. 4 shows a sample action, in three parts A, B and C, by the frame re-timing step 214 where a pan is too slow. It is important to note, once again, that the example of FIG. 4 applies as well equally to a zoom or a rotation that is too slow. In part A, the original frames at time positions 411-415 start on the proper frame times 441-445, respectively.

In part B, when the frame re-timing step 214 is activated as a result of the panning speed being too slow, and thus beyond the allowable guidelines, frame re-timing step 214 corrects the slow motion of the pan by moving the frames closer together in time, effectively speeding up the motion. Assuming that frame 1 at time position 411 stays in its original position on frame time 441, frame 2 at time position 412 is moved to a new position 422. Likewise, frame 3 at time position 413 is moved to time position 423, frame 4 at time position 414 is moved to time position 424 and frame 5 at time position 415 is moved to time position 425.

The moved frames at time positions 422-427 are not on proper frame times 441-445 and are thus not easily displayed at their new times. To produce a valid video stream, new frames must be generated in step 216 that are on the standard frame times 441-445.

The generated frames are shown in part C, and labeled 1′-5′. The time positions of frames 1′-5′ are numbered 431-435, respectively. These new frames are not copies of the original frames, but are generated by interpolation from the originals with image adjustments for the time difference between the new time placement of the original frames at time positions 421-424 and the required time positions of 431-435. The adjustments are based on the change in position of the contents of the frame due to the pan, zoom or scroll that is being effected, plus any change in position of the contents of the frame due to objects moving (e.g. a person walking).

To properly generate frames 1′-5′ at time positions 431-435, both the above types of image movements must be interpolated to make sure that every image element is in the proper position for the times 441-445 when the generated frames at time positions 431-435 will be displayed.

Frames 2 and 3 at time positions 412, 413 are moved closer in time and placed as frames 2 and 3 at time positions 422, 423. These two frames and their camera motion estimates, along with their dense motion field for object motion, are used to create the new frame 2′ at time position 432 to be displayed at time 442. Likewise, frame 3 at time position 423, and frame 4 at time position 424 are used to create 3′ at time position 433 at time 443. This process continues through the entire set of re-timed segments.

The result of the example shown in FIG. 4 is that less time is needed to arrive from the image shown in frame 1 to the image shown in frame 5, effectively speeding up the pan.

The new interpolated set of frames will start with the first frame which will be the original first frame of the sequence and is not an interpolated frame. In those unusual instances, when a retimed frame falls on a standard frame time, the retimed frame is preferably used in the new sequence of frames instead of an interpolated frame.

The method illustrated in FIGS. 3 and 4 can be applied to a zoom as well. The video frames in a zoom are typically centered around one subject, unlike as in a pan, however the same method applies. The sequence of frames from lower zoom to higher zoom or vice versa is analogous to a sequence of frames where the subject changes, as in a pan. It is still possible to calculate a dense motion field from one frame to the next, and thus to detect that one or more guidelines have been exceeded. Similarly, it is also possible to re-time the zoom frames so as to spread out the images in time when the zoom is too fast, or to bring the frames closer together in time when the zoom is too slow. Interpolation between frame pairs in a re-timed zoom sequence works in the same way as for a pan.

While various embodiments of the present invention have been described above, it should be understood that they have been presented by way of example only, and not limitation. Thus, the breadth and scope of the present invention should not be limited by any of the above-described exemplary embodiments, but should instead be defined only in accordance with the following claims and their equivalents.

What is claimed is:

1. A method for correcting a video for undesirable camera motion rate comprising detecting the existence of an undesirable camera motion rate represented in a first sequence of video frames comprising a motion picture, and retiming frames of said first sequence of video frames in accordance with a desirable camera motion rate to produce a retimed sequence of frames.

2. A method as recited in claim 1 wherein the undesirable camera motion is detected by detecting the rate of camera motion from said first sequence of video frames.

3. A method as recited in claim 2 wherein the camera motion is detected by generating dense motion vector fields representing motion of image elements at the frames of said first sequence, and determining a camera motion from said dense motion vector fields.

4. Method as recited in claim 1 wherein a new sequence of frames are produced at a standard video frame rate by interpolating new frames between the frames of said retimed sequence.

5. A method as recited in claim 4 further comprising generating dense motion vector fields between the frames of said original sequence, and wherein said new frames are interpolated between the frames of said retimed sequence using said dense motion vector fields.

6. A method as recited in claim 1 further comprising determining the presence of a soundtrack in said motion picture and resynchronizing said soundtrack with the timing of the frames in said retimed sequences.

7. A method as recited in claim 1 wherein said camera motion is the panning of said camera.

8. A method as recited in claim 1 wherein said camera motion is the zooming of said camera.

9. A method as recited in claim 1 wherein the existence of an undesirable camera motion rate is detected by determining that the camera motion exceeds at least one guideline.

10. A method as recited in claim 1 further comprising generating a new sequence of frames comprising new frames interpolated at predetermined times between the frames of said retimed sequence.

11. A system for correcting a video for undesirable camera motion rate comprising a video motion picture source, and video processor connected to receive video frames representing a motion picture from said video source, said video processor operating to identify a first sequence of frames in said video in which the camera motion exceeds at least one guideline, and to retime the frames in said sequence to mitigate the effect of the guideline being exceeded, whereby a retimed sequence of frames is provided.

12. A system as recited in claim 11 wherein said video processor detects camera motion from said first sequence of video frames to determine whether the camera motion exceeds said at least one guideline.

13. A system as recited in claim 12 wherein said video processor determines the camera motion represented in said first sequence of frames by detecting a dense motion vector field between the frames of said sequence.

14. A system as recited in claim 11 wherein said video processor operates to produce a new sequence of frames occurring at a standard video frame rate, said new sequence comprising new frames interpolated between the frames of the retimed sequence of frames.

15. A system as recited in claim 14 wherein said video processor generates dense motion vector fields representing the motion between the frames of said first sequence and wherein said new frames are interpolated between the frames of said retimed sequence using said dense motion vector fields.

16. A system as recited in claim 11 wherein said video motion picture contains a soundtrack and wherein said video processor resynchronizes said soundtrack in accordance with the timing of the frames of said retimed sequence.

17. A system as recited in claim 11 wherein said camera motion comprises camera panning.

18. A system as recited in claim 11 wherein said camera motion comprises camera zooming.

19. A system as recited in claim 11 wherein said video processor operates to generate a new sequence of frames comprising new frames produced by interpolation between the frames of said retimed sequence.
